(19) United States
(12) Patent Application Publication
(10) Pub. No.: US 2006/0017740 A1
(43) Pub. Date: Jan. 26, 2006

(54) Diurnal variation of geo-specific terrain temperatures in real-time infrared sensor simulation

(76) Inventor: Christopher R. Coleman, Dallas, TX (US)

Correspondence Address: FISH & RICHARDSON P.C., P.O. BOX 1022, MINNEAPOLIS, MN, 55440-1022, US

(21) Appl. No.: 11/122,841

(22) Filed: May 4, 2005

Related U.S. Application Data
(60) Provisional application No. 60/591,066, filed on Jul. 26, 2004.

(51) Int. Cl. G09G 5/00

(52) U.S. Cl. 345/582

(57) ABSTRACT

A shader for dynamically providing diurnal variation in radiance-based imagery is operable to load a virtual texture comprising a plurality of texels, each texel storing a plurality of analogical parameters. The shader is further operable load a thermal lookup table indexed by the plurality of analogical parameters and to dynamically generate an at-aperture radiance image for one of a plurality of times of day based on the loaded virtual texel and the thermal lookup table.

### RELATED APPLICATION

This application claims the priority under 35 U.S.C. §119 of provisional application Ser. No. 60/591,066 filed Jul. 26, 2004.

### TECHNICAL FIELD

This disclosure generally relates to computer graphics and, more specifically, to infrared sensor simulation.

### BACKGROUND

Infrared (IR) is electromagnetic radiation of a wavelength longer than visible and ultra-violet light, but shorter than microwave signals. IR is commonly subdivided into various spectral bands based on wavelength. For example, IR may be described as one of the following: i) near infrared (NIR), which is 0.78-1 μm in wavelength; ii) short wavelength infrared (SWIR), which is 1-3 μm in wavelength; iii) mid wavelength infrared (MWIR), which is 3-8 μm in wavelength; iv) long wavelength infrared (LWIR), which is 8-12 μm in wavelength; and v) very long wavelength infrared (VLWIR), which is 16-21 μm in wavelength. While these categories and their associated wavelengths may differ from device to device, they often serve as useful terms for describing such devices.

One device may be a sensor (or an imaging system) capturing a two-dimensional, quantitative, radiometric image of an environment into time-variant electrical signals. These signals can be sub-sampled to a variety of output formats specific to the intended application for the sensor. Typical sensors include low-light television (LLTV), night vision goggles (NVGs), and Forward Looking Infrared (FLIR) systems, each operating in a unique portion of the electromagnetic spectrum. For example, image intensifier (I2) devices operating in the visual to NIR spectral bands may include NVGs, pilots, dismounted infantry, and night scopes. In another example, medium and long wave infrared (MWIR and LWIR, respectively) devices for the military may include missile seekers, navigation pods, targeting cameras, thermal sights, night vision aids, and Unmanned Aerial Vehicles (UAVs).

### SUMMARY

This disclosure provides a system, method, and software for various processes involved in infrared sensor simulation. For example, the system may include or execute software for material classification of an image. The software typically comprises computer-readable instructions and is operable to identify a first image of a first type with a first resolution, the first type comprising a visible image. The software is further operable to identify a second image of a second type with a second resolution, with the second image spatially correlated with the first image and the second type comprising a material image. The software then generates a third image of the second type with the first resolution using the first and second images.

In a further example, the system may comprise or execute software operable to add spatial frequency to an image. The software is operable to identify a higher resolution, course grain material image. The software is further operable to generate a course grain sensor image using the material image and to add spatial frequency to the sensor image using a high frequency image to generate a high frequency sensor image.

In another example, a supervised neural network for encoding continuous curves comprises at least one input node operable to receive input data for predicting a temperature for a thermal curve at one of a plurality of times of day. The neural network further comprises a hidden layer of a plurality of hidden nodes, at least a portion of the hidden nodes communicably coupled to the one or more input nodes. The neural network also includes an output node communicably coupled to at least a portion of the hidden nodes and operable to predict thermal properties of a material at the particular time of day. A method for runtime reconstruction of continuous curves using a dependent texture lookup may comprise training a neural network using supervised learning and a sparse set of input data. The neural network is queried to create a continuous decision space, with the continuous decision space representing a dependent texture lookup in at least one multi-texture stage of a GPU and the query based on a minimum-maximum range of input data. The method may further comprise dynamically processing the continuous decision space to reconstruct a particular point on one of the input curves based on an indexed texture.

In yet another example, the system may comprise a shader for dynamically providing diurnal variation in radiance-based imagery is operable to load a virtual texture comprising a plurality of texels, each texel storing a plurality of analogical parameters. The shader is further operable load a thermal lookup table indexed by the plurality of analogical parameters and to dynamically generate an at-aperture radiance image for one of a plurality of times of day based on the loaded virtual texel and the thermal lookup table.

All or a portion of such a system for performing infrared sensor simulation may use a variety of techniques aimed at simplifying material classification, obtaining better image fidelity, encoding temperature data using a neural network, and/or obtaining the ability to determine at-aperture radiance that responds to per-texel surface temperatures for any simulated time of day at runtime. Of course, various embodiments of the disclosure may have none, some or all of these advantages. The details of one or more embodiments of the example systems and techniques are set forth in the accompanying drawings and the description below. Other features, objects, and advantages will be apparent from the description and drawings, as well as from the claims.

### DESCRIPTION OF DRAWINGS

FIG. 1 is an illustration of an example system providing infrared sensor simulation in accordance with certain embodiments of the present disclosure;

FIGS. 2A-B are example data flow diagrams implemented by the development environment to classify various materials in accordance with certain embodiments;

FIGS. 3A-F provide example textures used or generated during material classification of an environment;

FIGS. 4A-B illustrate an example layout of a neural network for encoding continuous thermal curves that implements various functions in certain composite nodes;

FIGS. 5A-C are example graphs illustrating various thermal curves of particular materials;

FIGS. 6A-C illustrate training data and lookup tables for the neural network of FIG. 4A; and

FIG. 7A-B illustrate example user interfaces of the development environment for certain portions of material classification.

### DETAILED DESCRIPTION

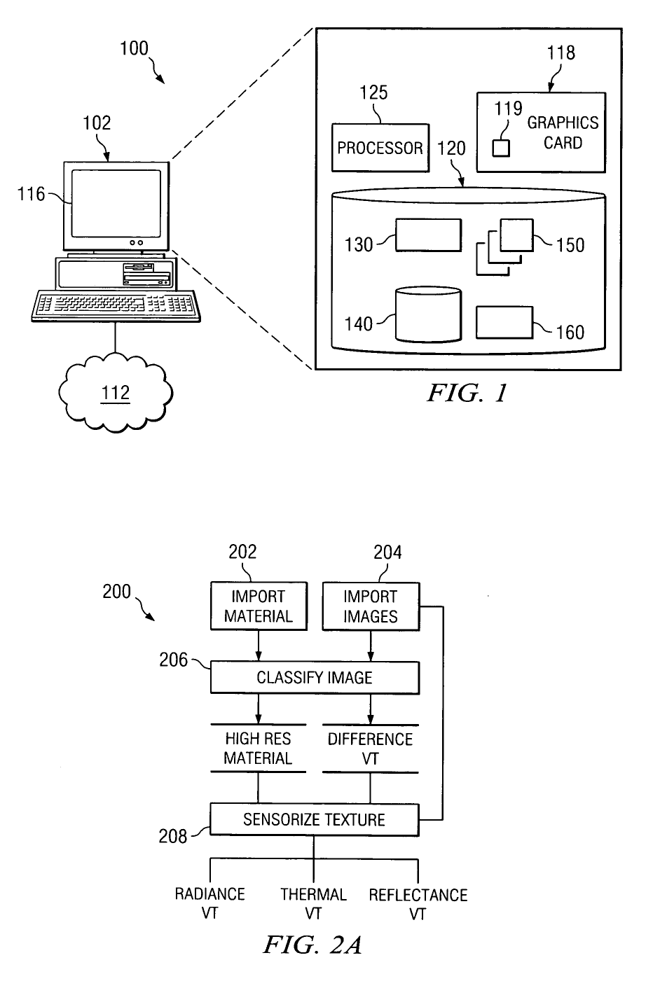

FIG. 1 is an illustration of an example system 100 providing infrared sensor simulation. At a high level, system 100 computes and displays quantitative infrared sensor images of any suitable environment containing natural backgrounds, cultural features, and dynamic objects as appropriate. More specifically, system 100 may (in certain embodiments) be operable to provide real-time, physics-based, band-specific scene generation at wavelengths from the visible through the far infrared, while supporting dynamic changes in scene temperatures and diurnal effects. For example, system 100 may compute the apparent radiance of a scene from the position and orientation of the observer, producing quantitative radiance values in each pixel in units of watts/cm2/steradian. In other words, system 100 may produce scenes calibrated in radiometric units based on first-principle physics. System 100 may generate accurate spectral response of the sensor and then add sensor effects such as noise, blur, sensor non-uniformities, and jitter to the image. System 100 may also provide image effects for training applications where the observer (or user) sees the scene via a sensor rather than out-the-window and may also have the capability of providing the major effects associated with a wide range of visible and infrared sensors. In certain embodiments, multiple sensors can be simulated and viewed simultaneously in a multi-channel display.

Sensor images include a plurality of texture elements and are used for presentation of various graphics to the user. The sensor images are typically used to generate radiance at run-time using a graphics card for quick presentation. Moreover, these images may be stored in any format after computation and may be in one table or file or a plurality of tables or files stored on one computer or across a plurality of computers in any appropriate format. Further, images may be local or remote, as well as temporary or persistent, without departing from the scope of this disclosure. In certain embodiments, system 100 may automatically collect material textures and atmospheric data and dynamically apply a radiometric equation to the inputs on a per texel basis to generate the sensor image. The term “automatically,” as used herein, generally means that the appropriate processing is substantially performed by at least part of system 100. It should be understood that “automatically” further contemplates any suitable user or developer interaction with system 102 without departing from the scope of this disclosure. The term “dynamically,” as used herein, generally means that certain processing is determined, at least in part, at run-time based on one or more variables. System 100 may implement some or all of a variety of techniques for enhancing infrared simulation including automatically providing better material per-texel classification, improving image quality, encoding and compressing temperature curves using a supervised neural network, and/or dynamically determining contribution of surface temperature using a geo-specific thermal texture database and a thermal look-up texture.

For example, system 100 may classify (or identify classification values for each pixel in) a first image (often high-resolution), using a spatially correlated second image (typically low-resolution) for guidance. The spatial location of each pixel in the first image is used to locate a corresponding pixel in the second image to obtain a gross-classification value. The gross-classification value is used to select a table of fine-classifications. The one or more image values of the pixel from the first image is then compared to the one or more values of the entries in the selected fine-classification table. The result is a third image (normally with the same resolution as the first image) containing classifications obtained from the set of fine-classifications. Accordingly, system 100 may allow for specific materials for the area being simulated to be easily added, may provide detailed, quantitative infrared sensor images for comprehensive backgrounds, features, and objects, may be visually or analytically specified for a wide range of sensors, and/or providing enhanced performance by allowing users to produce analytically correct effects based on real-world sensor parameters and supporting hardware sensor effects.

In yet another example, system 100 may provide enhanced material classification by combining the spatial frequency of source imagery with images created from a material classification of the source imagery. The material classification can use a relatively small number of materials compared to the millions of possible color or intensity combinations in the original source imagery. Brightness of the source imagery may be used directly to add spatial frequency into the final imagey or the small variations between the source imagery and the material classification's predicted visible color (often called a difference image) may be used to add spatial frequency into the final image.

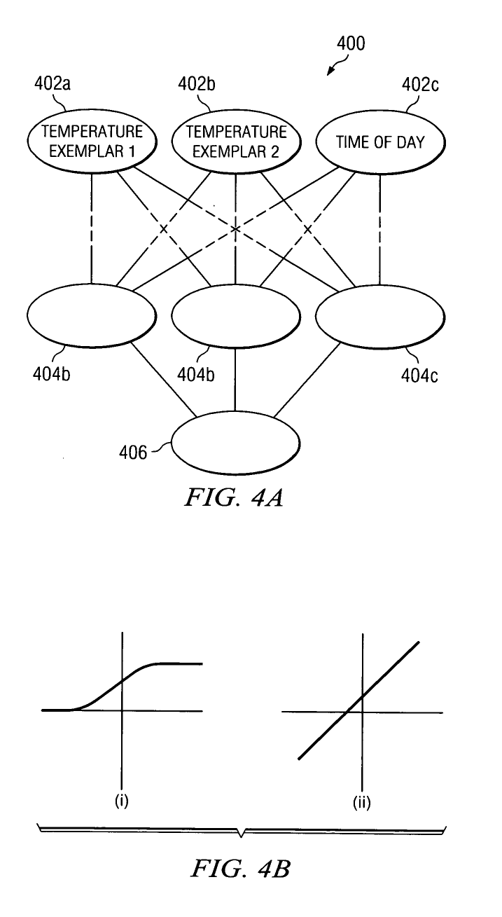

Once the appropriate one or more materials have been identified for a particular environment, system 100 may determine various infrared properties of the environment's materials and their properties. For example, one technique uses a class of artificial neural networks, as illustrated in more detail in FIGS. 4A-B, to encode sets of continuous thermal curves into a look-up table 160 using analog descriptors of the curves as input. The smooth table of a fixed size may be generated from a sparse set of data such that any point on any of the input curves can be accurately recovered, as well as blends between two or more curves representing the average. Appropriate input parameters may be chosen to describe the curves while minimizing data collisions and providing for smooth transitions between curves. In this example, system 100 trains the neural network using supervised learning to encode an input data set. After training is suitably completed, the continuous decision space is created by querying the neural network based on the min-max range of the input data to create look-up table 160 of thermal outputs. In other words, look-up table 160 may be used at runtime to reconstruct the original curves and any combination of curves that are the result of index averaging. This may be done without pre-computing the combination curves ahead of time, thereby possibly saving time, reducing required processing power, and/or increasing the scope of the usable data. For example, this technique may provide at-aperture radiance for infrared sensor simulation that responds to changes in per-texel surface temperatures as a function of simulated time-of-day via the encoded thermal curves. A geo-specific texture database and separate look-up table encode a 24-hour temperature cycle based on each texel's material and (optionally) surface orientation and altitude. The indices of the textures are created using properties of the temperature curves rather than materials directly such that the runtime temperature lookup allows range-based texel averaging (i.e. mip-mapping and texture filtering) to be performed on the indices prior to look-up. In short, these example thermal index textures are typically independent of time of day.

Returning to the example illustration, system 100 includes at least one computer 102, perhaps communicably coupled with network 112. Generally, computer 102 provides a developer with an environment operable to develop or generate infrared scenes. Computer 102 is typically located in a distributed client/server system that allows the user to generate images and publish or otherwise distribute the images to an enterprise or other users for any appropriate purpose. But, as illustrated, computer 102 may be a standalone computing environment or any other suitable environment without departing from the scope of this disclosure. Generally, FIG. 1 provides merely one example of computers that may be used with the disclosure. For example, computer 102 may comprise a computer that includes an input device, such as a keypad, touch screen, mouse, or other device that can accept information, and an output device that conveys information associated with the operation of computer 102, including digital data and visual information. Both the input device and output device may include fixed or removable storage media such as a magnetic computer disk, CD-ROM, or other suitable media to both receive input from and provide output to users of computer 102 through the display. As used in this document, the term “computer” is intended to encompass a personal computer, touch screen terminal, workstation, network computer, kiosk, wireless data port, wireless or wireline phone, personal data assistant (PDA), one or more processors within these or other devices, or any other suitable processing device. For example, the present disclosure contemplates computers other than general purpose computers as well as computers without conventional operating systems. Computer 102 may be adapted to execute any operating system including Linux, UNIX, Windows, Windows Server, or any other suitable operating system operable to present windows. According to one embodiment, computer 102 may be communicably coupled with a web server (not illustrated). As used herein, “computer 102,” “developer,” and “user” may be used interchangeably as appropriate without departing from the scope of this disclosure. Moreover, for ease of illustration, each computer 102 is described in terms of being used by one user. But this disclosure contemplates that many users may use one computer or that one user may use multiple computers to develop new texture elements or sensor images.

Illustrated computer 102 includes graphics card 118, memory 120, and processor 125 and comprises an electronic computing device operable to receive, transmit, process, and store data associated with generating images, as well as other data. Graphics card 118 is any hardware, software, or logical component, such as a video card, display adapter, or other programmable graphics hardware (or GPU) operable to generate or present a display to the user of computer 102 using GUI 116. Indeed, while illustrated as a single graphics card 118, computer 102 may include a plurality of graphics cards 118. In certain embodiments, graphics card 118 includes video or texture memory that is used for storing or processing at least a portion of graphics to be displayed. Graphics card 118 may also be capable of running one or more shader programs 119, thereby allowing for surface temperature databases to be encoded into a single multi-texture stage. Graphics card 118 may utilize any appropriate standard (such as Video Graphics Array (VGA)) for communication of data from processor 125 to GUI 116. While illustrated separately, it will be understood that graphics card 118 (and/or the processing performed by card 118) may be included in one or more of the other components such as memory 120 and processor 125. Processor 125 executes instructions and manipulates data to perform the operations of computer 102 such as, for example, a central processing unit (CPU), a blade, an application specific integrated circuit (ASIC), or a field-programmable gate array (FPGA). Although FIG. 1 illustrates a single processor 125 in computer 102, multiple processors 125 may be used according to particular needs and reference to processor 125 is meant to include multiple processors 125 where applicable. In the illustrated embodiment, processor 125 executes development environment 130, which performs at least a portion of the classification of materials, training of the neural network, and/or generating the sensor image.

Development environment 130 could include any software, firmware, or combination thereof operable to sensor images or other present graphics to one or more users or viewers and/or to develop, customize, or otherwise dynamically generate sensor images by using, among other things, material classifications and/or encoded thermal curves. For example, development environment 130 may generate the image visualization using the following inputs: i) out-the-window (OTW), photo texture and other multispectral files; ii) material classified textures and optionally pre-generated radiance or reflectance textures to associate texture colors with real world materials and to generate sensor textures; iii) a database of atmospheric quantities and material surface temperatures that describes the atmospheric states (weather conditions), defines spectral band of the sensor, and provides look up table at runtime for pre-computed sensor quantities; and iv) a materials database, which contains the thermal properties and spectral reflectance data for materials. Development environment 130 may be written or described in any appropriate computer language including C, C++, Java, J#, Visual Basic, Perl, assembler, any suitable version of 4GL, and others or any combination thereof. It will be understood that while development environment 130 is illustrated in FIG. 1 as a single multi-tasked module, the features and functionality performed by this engine may be performed by a plurality of modules such as, for example, a material classifier, neural network 400, an atmospheric tool, a sensor image simulator, and others. Further, while illustrated as internal to computer 102, one or more processes associated with development environment 130 may be stored, referenced, or executed remotely. Moreover, development environment 130 may be a child or sub-module of another software module (not illustrated) without departing from the scope of this disclosure.

Memory 120 may include any local or remote memory or database module and may take the form of volatile or non-volatile memory including, without limitation, magnetic media, optical media, random access memory (RAM), read-only memory (ROM), removable media, or any other suitable memory component. In the illustrated embodiment, memory 120 includes development environment 130, materials database 140, a lookup table 160 representing encoded thermal curves during a 24-hour period for each material and surface orientation/altitude, and textures 150 or other files that help identify elevation, imagery, materials, and/or features of particular environments. Generally, elevation data defines the “shape” of the terrain, which can be converted to 3D polygonal form as a terrain skin or to raster form as a normal map (or bump map). Imagery identifies what the terrain “looks like.” Imagery or other out-the-window photos may come in many geo-specific formats including satellite, overflight or orthophoto (often each format conveys the color (or intensity in the visible color band) at each geo-specific pixel location). Material textures identify “what” exists at each geo-specific pixel location such as, for example, “grass”, “asphalt” or “water” and features identify “what” exists at point, line, and polygonal vectors such as, for example, a building, road, or forest. Of course, memory 120 may also include other appropriate data such as an atmospheric database, a history log, DLLs, an operating system, security policies, and such.

Materials database 140 comprises of a number of materials in different categories: Soils, Vegetation, Rock, Construction, Composites, Hydrology, Pure Blackbody/Whitebody, and Paints such as Paint on Metal, Paint on Wood, Paint on Concrete, Paint on Asphalt, and Old Paint. For example, materials database 140 may include the following:

| Soils | Vegetation | Construction | Composites | Paints | Pure |
|---|---|---|---|---|---|
| Lump coal | Tundra | Roof tar | Black rubber | Jet black | Black |
| Water | Scrub | Black asphalt | White fabric | Snow white | White |
| Ice | Pine | Paved concrete | Grey fabric | Off white | |
| Fresh snow | Broadleaf | Block concrete | Brown plastic | Ash gray | |
| Old snow | Lawn grass | Asphalt shingles | Tan felt | Battleship | |
| Road gravel | Dry grass | Wood siding | Beige fabric | gray | |
| Limestone rock | Tree bark | Red brick | Cream | Blackish | |
| Sandstone rock | Scrub soil | Pine wood | fiberglass | brown | |
| Varnished | Grass soil | Clear glass | Gold nylon | Dark tan | |
| sandstone | Grass scrub | Oxidized | Olive plastic | Light tan | |
| Black sand | Pine scrub | aluminum | Green canvas | Sky blue | |
| White sand | Broadleaf | Rusting steel | Yellow silicon | Olive green | |
| Lake sand | scrub | Dark titanium | Orange epoxy | Kelly green | |
| Desert sand | Broadleaf pine | Metal roof | Red nylon | Mint green | |
| Beach sand | Pine broadleaf | Urban | | Canary yellow | |
| Loamy sand | Scrub grass | commercial | | Mustard | |
| Sandy loam | soil | Urban residential | | yellow | |
| Silty loam | | | | Bleached | |
| Silty clay | | | | yellow | |
| Clay soil | | | | Light red | |
| Loam soil | | | | | |
| Compact soil | | | | | |
| Tilled soil | | | | | |
| Wet soil | | | | | |
| Wet lakebed | | | | | |
| Dry lakebed | | | | | |
| Wet seabed | | | | | |
| Dry seabed | | | | | |
| Salt-silt | | | | | |
| Silt-sand | | | | | |
| Sand-soil | | | | | |
| Sandstone soil | | | | | |
| Limestone silt | | | | | |
| Limestone silt | | | | | |
| sand | | | | | |
| Limestone silt | | | | | |
| soil | | | | | |

This table may also include hydrology such as fresh snow, ice, old snow, and water. Of course, this table is for illustration purposes and materials database 140 may include none, some, or all of these example materials, as well as others. Users normally have the ability to generate an individualized geospecific database based on this database or to supplement or customize the existing one. For example, the user may expand this database by copying and modifying an existing material file. In another example, the material name may be changed and its associated thermal properties and the tabular listing of wavelength, reflectance pairs. In certain embodiments, values of diffuse spectral reflectance are stored from 0.42 to 14 μm for each material as well as the thermal properties for that particular material. For example, each record in materials database 140 may include some or all of the following example material properties:

| Label | Asphalt |
|---|---|
| Default Material | Asphalt |
| Solar Absorptivity | 0.90 |
| Thermal Emissivity | 0.95 |
| Characteristic Length (m) | 0.025 |
| Evaporation Index (Y/N) | NO |
| Specific Heat (w-sec/gm/K) | 0.90 |
| Conductivity (w/m/K) | 0.75 |
| Density (gm/m**3) | 2.00e6 |
| Surface Layer Thickness (m) | 0.0254 |
| Sub-layer 1 Thickness (m) | 1.0 |
| Sub-layer 1 Material | Packed Dirt |
| Sub-layer 2 Material | Limestone Rock |

In a further embodiment, materials database 140 may include, reference, or be coupled with a text file that specifies how to map a “color” in an input image to a particular material. For example, a typical entry may have the following format:
40, 80, 140, 1—“water”
0.041903, 0.043976, 0.043648, 2—“black rubber”
0.3962, 0.4168, 0.424, 3—“metal roof”
   The first example maps the RGB color <40, 80, 140> to a material index of <1>, which in this case represents water. This illustrates one embodiment where the user's source data is color imagery in which a color represents a particular material (for example, where a material is represented by a familiar color such as brown for dirt and blue for water). If instead the user has source files with indices into lookup tables, then the map may have the following format to map an index to an index:
1, 1, 1, 1—“Water”

Materials database 140 may also include, reference, or be coupled with a text file, perhaps termed a sub-material map, which specifies how the index above maps to a more specific material. For example, development environment 130 may use this map to create additional materials in the output dataset for any given material in the input dataset. Indeed, a single material often maps to several materials. For example:

| | | |
|---|---|---|
| 41 | Mixed Forest | (the original material) |
| 5 | Number of SubMaterials | (has 5 sub-materials) |
| 47 | Broadleaf-Pine | (the 1st sub-material) |
| 38 | Broadleaf | (the 2nd sub-material) |
| 43 | Grass-Soil | (the 3rd sub-material) |
| 49 | Scrub-Grass-Soil | (the 4th sub-material) |
| 46 | Broadleaf-Scrub | (the 5th sub-material) |

In this case, the material texel represented by index “41” will be further subdivided into one, (or more, if the output dataset has more than one material per texel) of 5 materials when processed by the tool. This allows enhancement of the input material classification data. But if the user already has high resolution material data, and he doesn't want to modify such input, then he may only specify a 1-to-1 mapping in the sub-material map, such as:

| | | |
|---|---|---|
| 47 | Pine Trees | (the original material) |
| 1 | Number of SubMaterials | (has 5 sub-materials) |
| 47 | Broadleaf-Pine | (sub-material is practically the same) |

This example demonstrates that an input material classification may be a 1-to-1 mapping and the output material for any given texel can be the same as the input. But system 100 contemplates any particular format, data, indexing, or other technique to enhance the material classification.

Textures 150 include any parameters, variables, tags, algorithms, or other data structures operable to present a graphical or virtual texture. As generally described herin, texture 140 includes a plurality of texture elements (sometimes referred to as “texels”). Texels commonly refer to what is retrieved from texture memory when the graphics sub-system, such as 118, asks for the texture information that should be used for a given pixel in the frame buffer. The retrieval typically includes processes like minifiction, magnification, anisotropic filtering, and such. In other words, each texture element characterizes the smallest graphical element in two-dimensional electronic texture mapping to the generation of the sensor image, which gives the visual impression of a textured three-dimensional surface. Certain textures 150 or images may be automatically or manually created using Application Programming Interfaces (APIs) or other tools, purchased from vendors, downloaded, or otherwise identified and stored using any technique. Indeed, these textures 150 may be imported from a vendor in a particular format and converted into a more efficacious format as appropriate. In one embodiment, textures 150 may be stored using one or more eXtensible Markup Language (XML) documents or other data structure including tags. In another embodiment, textures 150 may be stored or defined in various data structures as in a relational database described in terms of SQL statements or scripts, Virtual Storage Access Method (VSAM) files, flat files, Btrieve files, comma-separated-value (CSV) files, object-oriented database, internal variables, one or more libraries, or a proprietary format. For example, these textures 150 may be stored in a persistent file available to one or more users. In short, textures 150 may be one table or file or a plurality of tables or files stored on one computer or across a plurality of computers in any appropriate format. Further, textures 150 may be local or remote without departing from the scope of this disclosure. Example textures include image textures, material textures, radiance textures, bump textures, reflectance textures, and/or thermal textures. Example geometries include terrain skin and/or 3D cultures.

Terrain skin (or shape) is generally used to occlude objects. For example, a city would not be seen behind a mountain or a truck should not be not seen behind a building. The terrain may also be used to provide normal vectors for hardware lighting. Further, the normal vectors may be stored per vertex and the spacing between vertices in the terrain is often greater than size of the hills. The terrain may be textured with either geo-specific image texture or typical texture, or both. Indeed, there may be large differences in the number of polygons and the number of graphics states implied by these various designs. Specifically, the use of geo-specific texture allows a single texture to cover entire tiles of terrain skin with a single graphics state. On the other hand, the use of typical textures implies that the terrain surface is segmented along feature boundaries and that each feature is textured individually. In this case, the terrain polygons could convey material information assuming that a material per feature were desirable.

Image texture is typically geo-specific texture representing the look of the terrain in some specific spectral wavelength band(s). Color imagery commonly uses three channels to convey the “red,” “green,” and “blue” segments of the visible spectrum. Color imagery shows the terrain as seen from a particular sensor at some time of day or year. Occasionally, the integration of multiple images taken at different times may cause visible seam lines in the resulting virtual texture. In this case, development 130 may automatically process the source data to radiometrically balance images and mosaicing of source images along natural boundaries (road, river) to mitigate these effects. In certain embodiments, development environment 130 may process feathers and blends imagery from different sources to further mitigate these effects.

Material textures are non-sensor-specific textures, normally representing the material or material composites that make up each texel. Material textures are typically indices to discrete values in a lookup table or materials database 140 such as, for example, 1, 1, 1, 1 or 40, 80, 140, 1 for “water.”

Radiance textures (may be considered a form of image texture or radiance imagery) are generally geo-specific textures representing the look of the terrain as modeled by a sensor in some specific spectral wavelength band. Radiance Imagery shows the terrain as seen from the sensor simulation at whatever time of day/year the synthetic-pictures were created for. The ability to create quality radiance imagery is a function of the sensor simulation's ability to represent the terrain shape, materials, and lighting effects at the time of day/year desired and in the wavelength band desired.

Bump Textures (or bump maps or imagery) are commonly raster files including normal vector information that can be used for hardware lighting. In certain embodiments, bump imagery may provide lighting information at a per-pixel resolution, thus helping to overcome previous designs that have too few vertices to effectively carry normal vectors. The may allow the mip-mapping effect of pixel rendering to smoothly transition LOD boundaries. Moreover, the resolution of the bump imagery may not have to match the resolution of the color, or reflectance imagery, thus allowing significantly lower demand on bandwidth.

Reflectance textures are generally geo-specific textures that capture reflectance characteristics of the terrain as modeled by a sensor in some specific spectral wavelength band and can be used for any time of day (it is normally time-of-day independent). Reflectance textures covering geo-specific terrain may be termed “reflectance imagery”.

Thermal textures are textures that capture thermal characteristics. Accompanying the thermal texture is thermal look-up table 160 generated by a neural network encoding continuous thermal curves. Although this texture is an index, its indices are analog in nature, allowing them to be MIP mapped with suitable image processing techniques.

3D Cultures are used to occlude objects. Typically, 3D Culture is mapped with typical textures. These example textures have similar abilities to the geo-specific texture types described above. But since the typical textures may be designed to fit in a fixed amount of run-time system memory, hybrid database designs may easily use one technique for texturing the terrain and another for texturing the 3D culture.

Memory 120 may also include an input atmospheric and surface temperature database to development environment 130. For example, development environment 130 may invoke, reference, or otherwise use a Moderate Spectral Atmospheric Radiance and Transfer (MOSART) module to compute the atmospheric quantities. For example, development environment may load, import, or output an atmospheric database or table that includes
Altitude dependent atmospheric parameters based on ray tracing from a given source location to a given observer position (or alternatively from a given observer position to a given source location); and
A table of atmospheric values including:
   a. The sensor's spectral response
   b. In-band thermal emissions
   c. Material heat-transfer lookups based on:
      i. Surface azimuth
      ii. Surface altitude
      iii. Surface slope
      iv. TOD
      v. Material type

Development environment 130 may also output material temperatures at 3 different altitudes, 4 azimuths, 4 surface slopes, and at a plurality of times of day for a geo-specific location. In other words, each material may be associated (for example) with 1152 data points comprising three altitudes, four azimuths, four slopes, one atmospheric state, and twenty four times of day. If multiple runs are made for each atmospheric state, then the combinations may increase fourfold. The inputs to development environment 130 are typically user-selected and include the number and choices for atmospheric states, the number and wavelength-response pairs for the spectral filters, and the parameterizations for the material surface temperatures and the atmospheric quantities. Example inputs include i) latitude and longitude; date; model atmosphere name; wind (Calm, Mean, Windy, User-defined); cloud cover and altitude, visibility range; humidity (Wet, Mean, Dry); and temperature (Hot, Mean, Cold). As with textures 150, atmospheric and surface temperatures may be stored using one or more extensible Markup Language (XML) documents or other data structure including tags. Moreover, atmospheric and surface temperatures may be stored or defined in various data structures as in a relational database described in terms of SQL statements or scripts, VSAM files, flat files, Btrieve files, CSV files, object-oriented database, internal variables, one or more libraries, or a proprietary format. For example, the atmospheric database or input file may have the following format:

1 {# of atmospheric states}
{1st state}
41 −112 {season: latitude (deg), longitude (deg)}
1995 2 18 {season: year [1950, 2050], month [1, 12], day [1, 31]}
Default {season: model atmosphere name}
Mean Mean Mean {weather: temperature, humidity, wind}
Clear 1 {weather: cloud cover, cloud base altitude (km) [1, 5]}
23 {weather: visibility range (km) (0, 100]}
1 {# of spectral bands}
{1st band}
100 {spectral resolution (1/cm)}
2 {# of wavelength-response pairs [2, 10000]}
3 1 {wavelength (microns), response [0, 1]}
5 1 {wavelengths in increasing order}
{parameterization for heat-transfer temperatures}
1 {# of materials}
ALL {material names follow}
3 {# of surface altitudes [1, 11]}
0 0.5 1 {altitudes (km) [0, 10)}
5 {# of surface orientation azimuths [1, 5]}
0 90 180 270 360 {azimuths (deg) [0, 90, 180, 270, 360]}
4 {# of surface orientation slopes [1, 4]}
0 20 50 90 {slopes (deg) [0, 180]}
25 {# of time-of-days [1, 97]}
{times (hours) [0, 0.25, 0.5, . . . , 23.75, 24]}
0 1 2 3 4 5 6 7 8 9 10 11 12 13 14 15 16 17 18 19 20 21 22 23 24
{parameterization for atmospheric quantities}
3 {# of line-of-sight ranges}
0.1 1 10 {ranges (km) [0.001, 1000]}
2 {# of observer altitudes}
0.1 1 {altitudes (km) [0.002, 1000]}
6 {# of line-of-sight elevations}
{(scaled) elevations (deg) [−90, 90]}
−90 −30 −5 5 30 90
6 {# of solar/lunar elevations}
{(scaled) elevations (deg) [−90, 90]}
−1 1 5 10 30 90
6 {# of solar/lunar-observer azimuths}
{azimuths (deg) [0, 180]}
0 90 140 170 178 180

Of course, this input file is for example purposes only and may not represent other input files. In other words, system 100 may use or implement an input file stored in any format and including any suitable data. In certain embodiments, system 100 may use such data to encode atmospheric and thermal properties into lookup table 160 via training of a neural network 400.

Computer 102 also includes or presents GUI 116. GUI 116 comprises a graphical user interface operable to allow the user of computer 102 to interface with various computing components, such as development environment 130, for any suitable purpose. Generally, GUI 116 provides the user of computer 102 with an efficient and user-friendly presentation of data provided by or communicated within the computer or a networked environment. In one embodiment, GUI 116 presents images, sensor simulations, and/or a front-end for development environment 130 to the developer or user. But GUI 116 may comprise any of a plurality of customizable frames or views having interactive fields, pull-down lists, toolboxes, property grids, and buttons operated by the user. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information and efficiently presents the results to the user. Computer 102 can communicate data to the developer, a web server, or an enterprise server via the web browser (e.g., Microsoft Internet Explorer or Netscape Navigator) and receive the appropriate HTML or XML responses using network 112 via an example interface.

In this example, computer 102 includes the interface for communicating with other computer systems, such as a server, over network 112 in a client-server or other distributed environment. In certain embodiments, computer 102 receives third party web controls for storage in memory 120 and/or processing by processor 125. In another embodiment, computer 102 may publish generated images to a web site or other enterprise server via the interface. Generally, the interface comprises logic encoded in software and/or hardware in a suitable combination and operable to communicate with network 112. More specifically, the interface may comprise software supporting one or more communications protocols associated with communications network 112 or hardware operable to communicate physical signals.

Network 112 facilitates wireless or wireline communication between computer 102 and any other local or remote computer, such as a web server. Indeed, while illustrated as one network, network 112 may be two or more networks without departing from the scope of this disclosure, so long as at least portion of network 112 may facilitate communications between components of a networked environment. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation of one embodiment, a developer identifies, selects, or generates out-the-window (OTW) images and material classification or land use classification textures. Often, the material classification textures are a lower resolution than the OTW or color imagery. In this case, the developer may instruct development environment 130 to chop the material classification texture, which takes the original land use/land classification data and re-tiles it so the coverage of the tiles substantially matches that of the visual OTW image tiles (which may already be tiled in the process of making a virtual texture). The developer may provide parameters or select among options to properly chop such data. For example, the OTW virtual texture may be imported in two levels of high resolution imagery (such as 0.4 m and 0.8 m). In this example, development environment 130 may notify the developer of the two resolutions and chop the material data entirely into 0.8 m tiles based on subsequent user input. Next, the developer may apply a material fusion process to the tiles using development environment 130. At a high level, material fusion identifies or selects sub-materials based on the material source and the OTW imagery source virtual texture. In certain embodiments, the developer or environment 130 may select sub-materials using a straight 20% chance based on the brightness of the OTW image. In other words, if the OTW brightness fell within the lowest 20%, then the sub-material would be the darkest associated material in the visible spectrum, the next 20% would result in the next brightest sub-material, and so forth. In alternative embodiments, the actual brightness of the sub-material is used directly. Put another way, development environment 130 compares the OTW brightness to each sub-material's brightness from the sub-material database or file and selects the closest or more appropriate associated sub-material. The difference between this “expected” brightness and the actual OTW brightness is then saved as a (often positive or negative) difference in a difference image. This difference image is generally the difference in the visible spectrum between the expected reflectance of the material and the actual reflectance in the OTW image. Essentially, the difference image represents the details of the image and includes a difference tile for each material tile, allowing for high resolution detail to be added to a sensor texture.

Once the materials texture has been identified, enhanced, or imported, development environment 130 processes each to produce the radiance texture. Development environment 130 typically evaluates a radiometric equation for each image pixel of each frame during runtime, but development environment 130 may generate radiance textures in a batch process for subsequent use or loading. The radiometric equation has five components, the sum of which is the total radiance.

$$\begin{matrix}{L}_{observer} = {L}_{direct} \cdot cos ( {θ}_{i} ) \cdot ρ \cdot ( 1 - frac ) \cdot {τ}_{path} & // diffuse solar \text{/} lunar reflection \\ + {L}_{direct} \cdot ρ \cdot frac \cdot {f}_{ang} \cdot norm \cdot {τ}_{path} & // specular reflection \\ + {L}_{ambient} \cdot ρ \cdot {τ}_{path} & // ambient reflection \\ + {L}_{thermal} \cdot ( 1 - ρ ) \cdot {τ}_{path} & // thermal emission \\ + {L}_{path} & // path emission and scattering \end{matrix}$$

L_{observer}=Radiance at Observer (W/cm²/steradian)
L_{direct}=Solar/Lunar Reflected Radiance at Surface (W/cm²/steradian)
L_{ambient}=Skyshine Reflected Radiance at Surface (W/cm²/steradian)
Lₜₕₑᵣₘₐₗ=Blackbody Radiance at Surface (W/cm²/steradian)
Lₚₐₜₕ=Atmospheric Path Radiance Between Surface and Observer (W/cm²/steradian)
Θᵢ=Angle Between Surface Normal and Direction to Sun/Moon in Degrees
ρ=Total Hemispherical Reflectance
τₚₐₜₕ=Atmospheric Transmission Between Surface and Observer
frac=Fraction of the Direct Radiance Reflected Specularly
f_{ang}=Angular Dependence of the Specular Term
norm=Specular Normalization Coefficient

The first component, solar/lunar reflections, symbolizes that when the sun and/or moon illuminate an environment with parallel rays of light, some of those rays are reflected into the hemisphere above the surface. The fraction reflected is referred to as the total hemispherical reflectance, ρ. This reflected light is separated into two components, specular and diffuse. The amount reflected specularly is denoted by frac and is typically confined to a small angle centered at the specular angle (when the reflected light is in the plane containing the surface normal and the light direction, and when the angles of incidence and reflectance are equal). Both the diffuse and specular components of a material are measurable.

The angular dependence of the specular term (a dimensionless quantity specifying the amount of the specular component reflected at the viewer angle) is denoted by fang and is controlled by the hardware shininess factor through the equation:
_{ang}=x^{(shininess)}
where x is an angle measure from the specular angle. It is the cosine of the angle between the vector sum of the illuminator and viewer directions and the surface normal. The direct and ambient reflection components of the sun and moon are given by:
L_{direct} cos θρ(1−frac)τ
and L_{ambient}ρfracf_{ang}normτ.
L_{direct} is the source illumination and is computed through the evaluation of the equation:

$${L}_{direct} = \frac{\frac{{A}_{sun / moon}}{π {R}_{1}^{2}} {\int }_{{λ}_{1}}^{{λ}_{2}} ϕ ( λ ) ( {L}_{sun / moon} ( λ ) {τ}_{R1} ( λ ) + {L}_{{R}_{1}} ( λ ) ) {τ}_{{R}_{2}} ( λ ) ⅆ λ}{{τ}_{path}^{*}}$$

where:
A_{sun/moon} area of sun/moon;
L_{sun/moon}(λ) spectral radiance of sun/moon;
τ_{R1}(λ) spectral transmission of R₁ path;
τ_{R2}(λ) spectral transmission of R₂ path;
φ(λ) sensor spectral response;
L_{R1}(λ) spectral radiance of R₁ path;
R₁ distance to sun/moon;
λ wavelength; and
τ*path is a transmission calibration factor for the path between the observer and the surface at the image center and is given by:

$${τ}_{path}^{*} = {\int }_{{λ}_{1}}^{{λ}_{2}} ϕ ( λ ) {τ}_{{R}_{2}} ( λ ) ⅆ λ$$

Skyshine reflections is given by L_{ambient}ρτₚₐₜₕ, where L_{ambient} is computed through the evaluation of the equation

$${L}_{ambient} = \frac{\frac{1}{π} {\int }_{{λ}_{1}}^{{λ}_{2}} {\int }_{0}^{2 π} {\int }_{0}^{π / 2} ϕ ( λ ) {L}_{R1} ( θ , ϕ , λ ) {τ}_{{R}_{2}} ( λ ) cos θ sin θ ⅆ ϕ ⅆ λ}{{τ}_{path}^{*}}$$

where φ(λ), τ_{R2}(λ), and τ*ₚₐₜₕ are as before and L_{R1} (θ, φ, λ) is the spectral radiance of the sky for elevation angle θ and azimuth angle φ. The integration is performed over the upper hemisphere. Development environment 130 typically evaluates L_{ambient} in a manner analogous to its evaluation of L_{direct}.

Thermal Emissions is given by Lₜₕₑᵣₘₐₗ(1−ρ)τₚₐₜₕ, where Lₜₕₑᵣₘₐₗ is given by

$${L}_{thermal} = \frac{1}{π} {\int }_{{λ}_{1}}^{{λ}_{2}} ϕ ( λ ) L ( λ ) ⅆ λ$$

and L(λ) is given by Planck's equation:
L(λ)=c₁/λ⁵(e^{c}^{₂}^{^{/λT}}−1)⁻¹
where:
c₁=2πc²h=3.7413×10⁻¹² W·cm²;
c₂=hc/k=1.4388 cm·K;
h=6.6252×10⁻³⁴ W sec²;
k=1.38042×10⁻²³ W sec/K;
c=2.99793×10¹⁰ cm/sec; and
T=temperature K
   In certain embodiments, thermal (emitted) energy may be rather difficult to compute or dynamically include for diurnal variation. Accordingly, development environment 130 may use the neural network to generate lookup table 160 for the thermal component based on analogical parameters that can be texture filtered and that return the thermal value directly, rather than a material. At run-time, a texture with the following 4 components is used:
R=Temperature Curve Point #1
G=Temperature Curve Point #2
B=In-band reflectance
A=Maximum Temperature
   The components of this texture are utilized by a vertex and fragment shader 119 to compute lighting, thermal, and fog components per-pixel which are combined into radiance for the current time of day per-frame. These parameters can be texture filtered and may even be compressed (using, for example, Digital Data Storage (DDS) compression).

Path Emissions and Scattering is given by

$${L}_{path} = {\int }_{{λ}_{1}}^{{λ}_{2}} ϕ ( λ ) {L}_{{R}_{2}} ( λ ) ⅆ λ$$

where L_{R2}(λ)=spectral radiance of R₂ path.

As described above, development environment 130 may process the radiometric equation through a dynamic runtime process or a batch process as appropriate. In one example, development environment 130 provides dynamic at-aperture radiance for infrared sensor simulation that responds to changes in per-texel surface temperatures as a function of simulated time of day. Development environment 130 reconstructs thermal curves and any combination of curves (based on average) using lookup table 160. During runtime, some or all of the following variables may change in value:
Observer altitude
View LOS elevation
View LOS azimuth from light source
Solar/Lunar elevation
LOS range between viewer and polygon
Time-of-day
   These are commonly referred to as the runtime controlling variables. As these variables change in value, so do certain quantities in the radiometric equation: L_{direct}, L_{ambient}, Lₜₕₑᵣₘₐₗ, τₚₐₜₕ, and Lₚₐₜₕ. Development environment 130 computes values of each of these quantities for a range of values of the runtime controlling variables. Within the atmospheric database, the terms L_{direct}, L_{ambient}, Lₜₕₑᵣₘₐₗ, τₚₐₜₕ, and Lₚₐₜₕ are evaluated by development environment 130 for a range of values of the controlling parameters. This typically results in a multivariate database for each quantity that is used to evaluate the respective terms of the radiance equation during runtime.

Sun/Moon Radiance (L_{direct}) and Skyshine Radiance At Surface (L_{ambient}) and are computed for user-selected values of:
1. Line-of-sight range between the observer and the surface,
2. Observer altitude,
3. Line-of-sight elevation angle,
4. Direct source elevation angle.
   During runtime, values of line-of-sight range, observer altitude, line-of-sight elevation angle, and direct source elevation angle are computed for each time step and then L_{direct} and L_{ambient} are computed using linear interpolation on this multivariate database.

For thermal blackbody radiance at surface (Lₜₕₑᵣₘₐₗ), in-band values of blackbody radiance are computed as a function of temperature over the range of possible surface temperatures. Development environment 130 computes surface temperatures for all user-specified materials as a function of user-selected values of: 1) surface altitude, 2) surface orientation azimuth angle relative to the north, 3) surface orientation slope relative to the horizontal, and 4) time-of-day. During runtime, development environment 130 may assign a temperature or thermal property per polygon according to the material combination and the current time using lookup table 160.

For atmospheric path transmission (τₚₐₜₕ) and path radiance (Lₚₐₜₕ), in-band values are computed for user-selected values of:
1. Line-of-sight range between the observer and the surface;
2. Observer altitude;
3. Line-of-sight elevation angle;
4. Direct source elevation angle;
5. Direct source and observer azimuth angle.
   During runtime, the values of τₚₐₜₕ and Lₚₐₜₕ are computed for the line-of-sight using linear interpolation on this multivariate database. This is done per image frame. The values of τₚₐₜₕ and Lₚₐₜₕ used in the radiance equation for each image pixel are computed using exponential extrapolation according to pixel line-of-sight range between the observer and the surface.

Alternatively, development environment 130 may execute a batch process to generate radiance textures (each texel quantitatively expressed in watts/cm2/steradian for a static time of day) by evaluating the radiometric equation on the material textures as a pre-processing step. These radiance textures can be subsequently loaded (as an option) and used in place of the radiance that may be computed by development environment 130 during runtime. This option is ideal for large textures being applied as virtual textures, or when the reduction of polygon count is either needed or desired. One advantage of using radiance textures is per-texel accuracy for the thermal component of the radiometric equation. Another advantage of radiance textures is that they allow the user to override the radiance that would be computed by development environment 130 during runtime such that specialized target signatures could be included with per-texel thermal variations. For example, generating a radiance texture for an object and editing the image file could be used to approximate internal heat sources. Infrared images taken of real-world objects, or the output of certain thermal modeling programs, may be used during modeling to create suitable radiance textures. Next, the developer or development environment 130 collects or identifies the resulting reflectance texture and adds the previously generated difference image, thereby creating a reflectance texture that has high frequency detail. In certain embodiments, development environment 130 may automatically (or in response to a request from the developer) filter both datasets using a simple N×N gaussian blur to minimize artifacts.

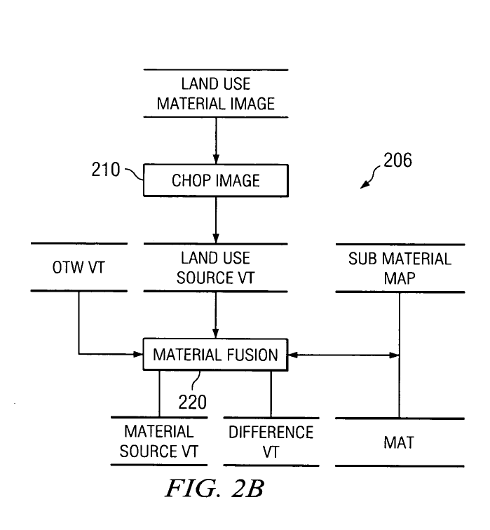

FIG. 2 is a data flow diagram illustrating an example method 200 for material classification. The following description focuses on the operation of certain components of development environment 130 in performing or executing algorithms to implement method 200. But system 100 contemplates using any appropriate combination and arrangement of logical elements implementing some or all of the described functionality.

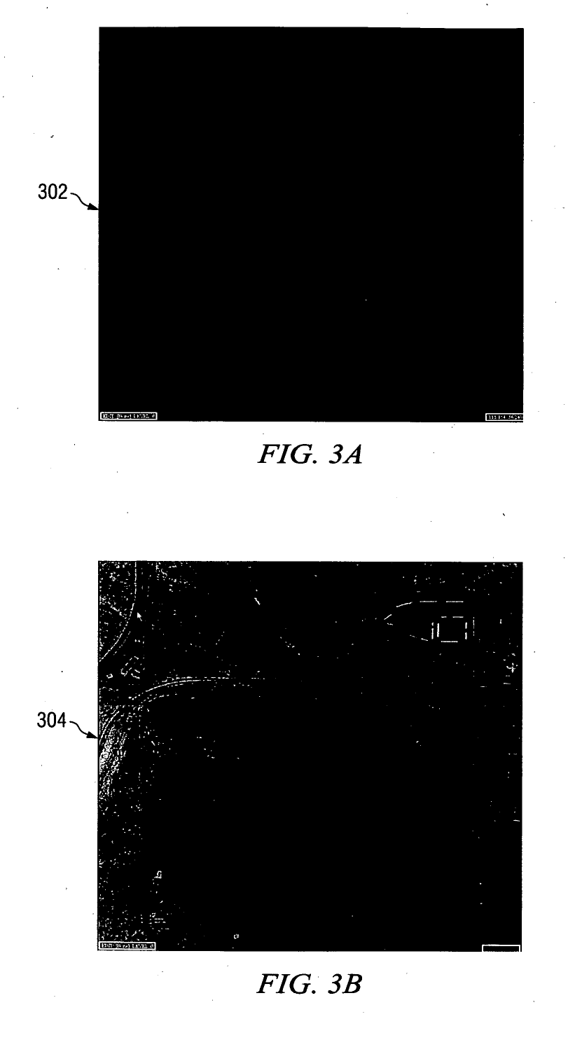

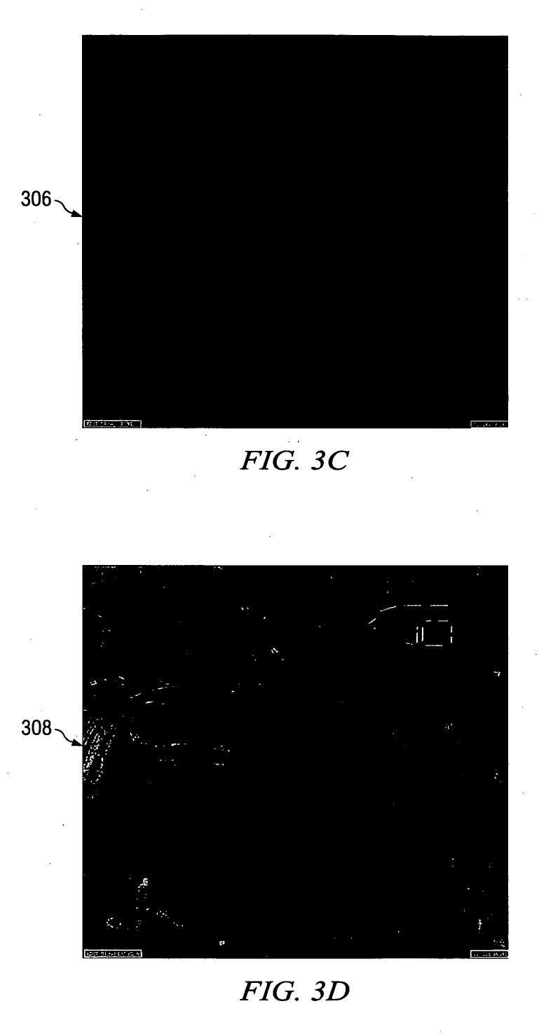

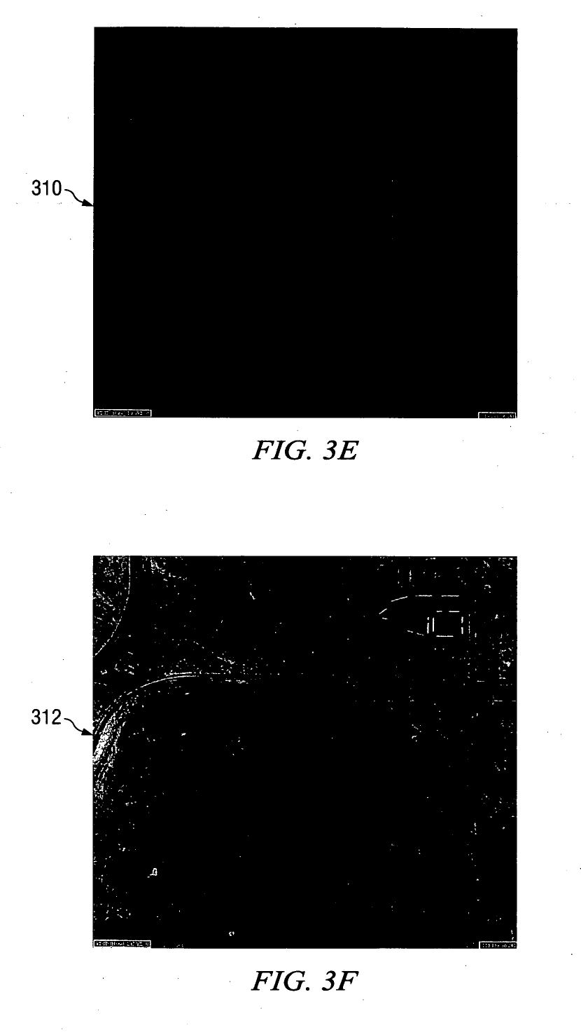

At step 202 and 204, development environment 130 loads, imports, generates, or otherwise selects material textures and images, respectively. For example, development may import 30m National Land Cover Data (NLCD) and out-the-window images into temporary storage. In this example, the NLCD is a 21-class land cover classification scheme commonly applied consistently over the United States. The spatial resolution of the NLCD data is normally 30 meters and mapped in the Albers Conic Equal Area projection, NAD 83. FIG. 3A illustrates example original material source. In this example, the material source is an indexed image where the grayscale value is the index of a material. FIG. 3B illustrates example OTW source imagery 304.

As appropriate (such as when the input material classification data is low resolution than the OTW imagery), development environment 130 creates high resolution material classification data 306 from low resolution material classification data and high resolution color imagery at step 206, as illustrated in more detail in 2B. As appropriate, the developer may instruct development environment 130 to chop the material classification texture at step 210, which takes the original land use/land classification data 302 and re-tiles it so the coverage of the tiles substantially matches the visual OTW image tiles 304 (which may already be tiled in the process of making a virtual texture). In this case, the brightness of imagery 304 is used to help sub-classify the above materials of source 302 at step 220. More specifically, development environment 130 may use the intensity of the color imagery 304 to add high frequency information to the material classification data 302, resulting in more variation of materials than originally existed. In other words, development environment 130 may create or identify more materials (called “sub-materials”), possibly resulting in more variety of materials. The user is often able to specify customized materials and sub-materials, as well as the number of sub-materials per gross material. The result of this material classification may be also used by any other suitable process that uses the material of a texel. This technique may be used to help create the sensor texture.

The result of this classification process is a file 306 for each tile in the OTW virtual texture, representing the material compositions of the texture, as illustrated in FIG. 3C. At the same time, development environment 130 may create a difference tile 308, which is the difference in reflectance in the visible spectrum between the material's calculated (or expected) reflectance and the actual reflectance as represented in the OTW imagery. This difference image 308, illustrated in FIG. 3D, is used in the creation of the sensor texture to add high frequency content to the sensor texture. Difference tile 308 may also be used in any other case where a delta reflectance may enhance the appropriate process or sensor (radar, etc.). In certain embodiments, each difference may be a signed difference, although it may be encoded into an unsigned number. In other words, development environment 130 may interpret this image 308 based on brighter areas having a positive difference and darker areas having a negative difference. This allows the difference to either add or subtract from the OTW brightness.

Next, development environment 130 uses high resolution material classification data 308 to create a sensorized texture 310, illustrated in FIG. 3E, at step 208. Development environment 130 may then combine the spatial frequency of source imagery 304 with images created from a material classification of the source imagery through, for example, an image fusion process. In one embodiment, development environment 130 may use the brightness of the source imagery 304 to add spatial frequency into the final image 310 or, alternatively or in combination, the small variations between the source imagery and the material classification's predicted visible color (difference image 308) can be used to add spatial frequency into the final image 310. For example, the sensorized texture 310 may then be fused with the difference texture 308 created above. In another example, development environment 130 may fuse the brightness component or other color component (perhaps red) of the color OTW imagery 304 with the reflectance texture 310 instead of the difference texture. Typically, each level of the input color imagery (in the form of a virtual texture) is processed. Generally, this results in a high resolution reflectance virtual texture 314, illustrated in FIG. 3F.

The preceding flowcharts and accompanying descriptions illustrate exemplary method 200, as well example details on certain steps. It will be understood that computer 102 contemplates using any suitable technique for performing this and other tasks. Accordingly, many of the steps in this flowchart may take place simultaneously and/or in different orders than as shown. Moreover, computer 102 may implement methods with additional steps, fewer steps, and/or different steps, so long as the methods remain appropriate. Further, it will be understood that FIGS. 3A-F are for example purposes only and none, some, or all of the example textures, images, or tiles (whether input or output) may be used. Indeed, such textures, images, and tiles may be in any suitable format (whether color, grayscale, or such) and represent, include, or reference any appropriate object, environment, material, and others.

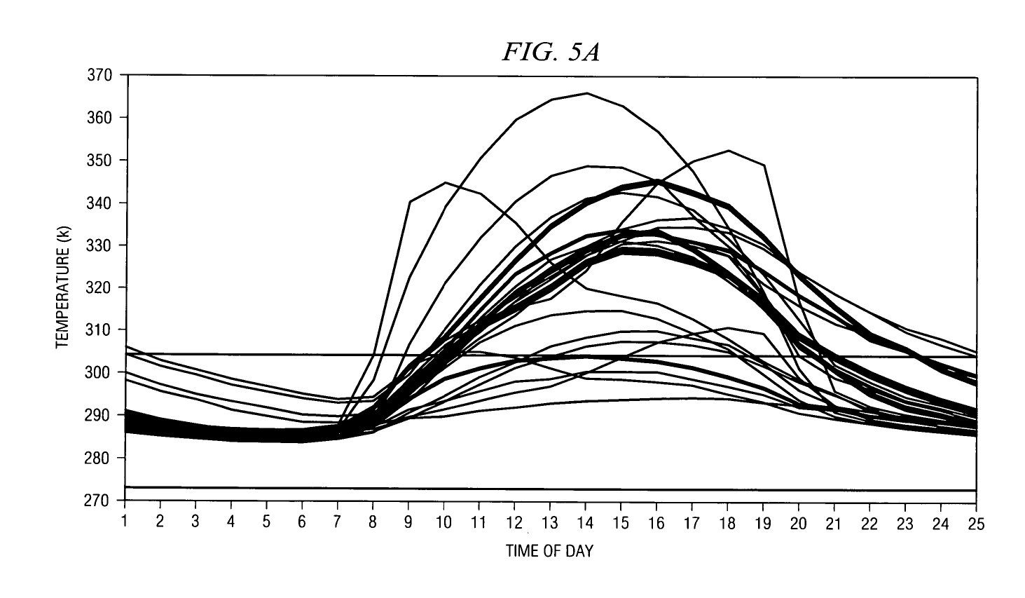

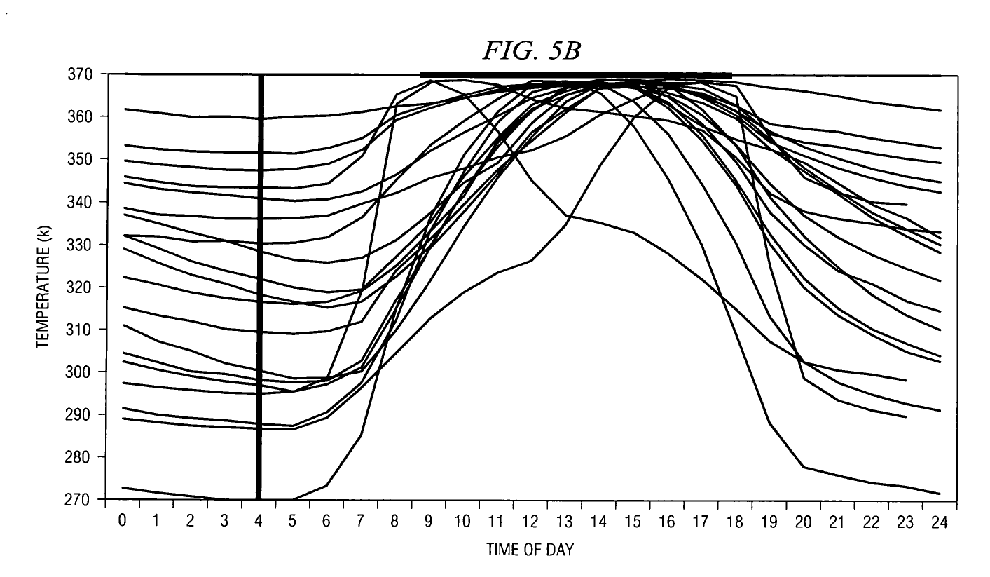

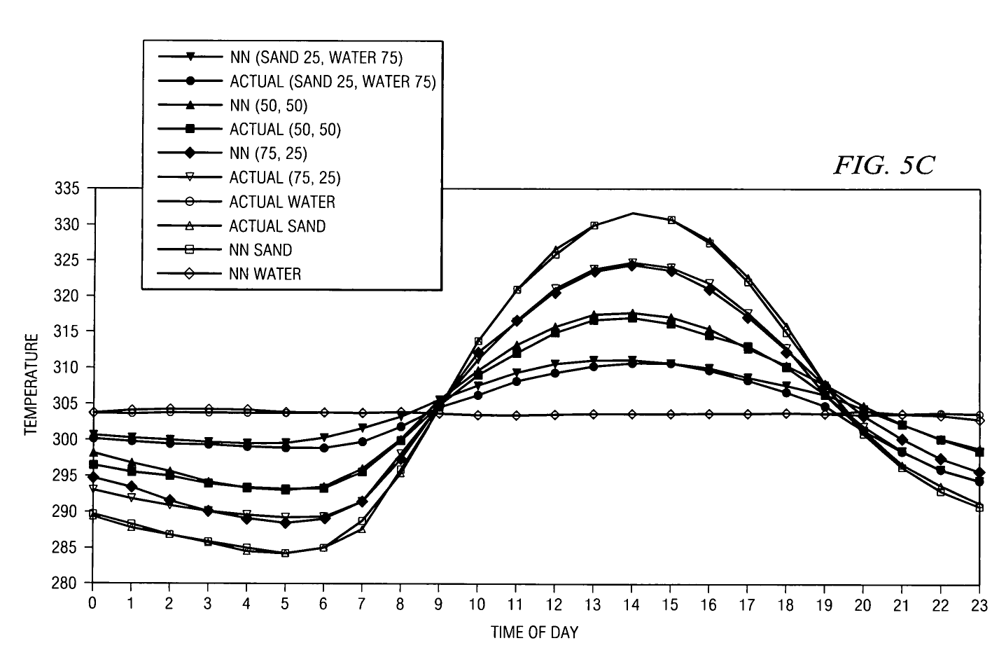

FIGS. 4A-B illustrate an example layout of a neural network 400 for encoding continuous thermal curves that implements various functions. Neural network 400 may allow system 100 to dynamically provide radiance-based imagery that responds to changes in material temperatures as a function of material type, simulated time-of-day, atmospheric states (cloudy, rainy, clear, etc), surface orientation, and surface altitude. Put another way, neural network 400 may create an on-disk representation that is material geo-specific yet independent of time-of-day and atmospheric state. This on-disk representation, or lookup table 160, may have a level of indirection that is used to index into a dependent database for temperature lookup at runtime. More specifically, indices that represent per-texel materials which mip-map, texture filter, can be stored in a single (virtual texture) database, and/or include the geo-specific material thermal properties for a plurality of times of day and for a plurality of atmospheric states. For example, FIG. 5A illustrates a plurality of material thermal curves for a particular location. Indeed, some of these illustrated thermal curves illustrate identical materials, but at different slopes.

As illustrated in FIG. 4A, neural network 400 may be implemented using a multi-layer perceptron (MLP). The MLP is a collection of nodes, also called neurons, organized into sequences of layers that are connected in various ways by connections, also called synapses. Neural network 400 typically includes an input layer for the input nodes 402, a layer for the output nodes 406, and any number of hidden layers and nodes 404. The number and type of nodes in each hidden layer may vary without departing from the scope of the disclosure. Typically, these layers are connected or coupled such that each node is connected to other nodes in the layer above it. Each connection normally has an associated weight that is used to decide how much of an output from a previous node is needed. Each node's job is to find a particular feature in the desired decision space and essentially replicate it. Other nodes may then use this feature as either a basis for another, possibly more complex, feature, or not at all based on the associated weight. Since subsequent layers draw upon the output from previous ones, increasing the number of layers in the network allows higher order feature detectors. In addition, to get more complex feature detectors from fewer layers, short-cut connections may be introduced into the network instead of every node having connections from the nodes in only the layer above it. In certain embodiments, three hidden layers may provide smooth results without an unsuitable increase in complexity. In further embodiments of neural network 400, only hidden nodes 404 have sigmoid activation functions (FIG. 4B(i)), while the output nodes 406 have a linear activation function (FIG. 4B(ii)). One benefit of implementing the sigmoid function is that it may make the values fall between 0 and 1.

Once neural network 400 is substantially generated or otherwise deemed suitable, the various weights of the connections may be refined using surface temperature data through training. In certain embodiments, neural network 400 is trained in a supervised manner by providing it with some true sample data and then allowing it to alter itself until it can replicate this data. Many algorithms exist for training neural network 400 such as, for example, back propagation. In the standard back propagation algorithm, the direction to move is scaled by a constant learning rate factor. This helps to prevent the network from taking too large of a learning step, or similarly to allow it to explore the error space in larger steps. Having this as a fixed value can cause problems in learning. If the error surface near the current position is very complex, then a large learning rate would miss details and overshoot the solution whereas a small rate would be more likely to find these and go directly towards a solution. Similarly, if the learning rate is small on a smooth portion of the error surface, then it would take a long time to cross it whereas a large learning rate would be able to go across much more quickly. But, in certain embodiments, back propagation may be supplemented by, for example, adding a momentum term to the weight updates and making the learning rate adaptive. The momentum term attempts to help the algorithm move quickly over very flat regions of the error space.

Neural network 400 may also implement more complex learning or training algorithms. One complex learning algorithm, quick propagation, works by extracting more relevant information (an estimate of the second-order surface features) and better guesses for the best direction to move. It makes two assumptions about the shape and relation of weights and errors, which may not apply to all problems. While these assumptions may not always be true, the actual surface is usually close enough to these properties, allowing quick propagation to operate correctly. But, quick propagation may introduce extra parameters that require some tweaking, as well some algorithmic changes. With certain initial weights, quick propagation may converge quickly and provide smooth results.

An alternative complex learning algorithm may be resilient propagation. This algorithm is similar to quick propagation in that it uses second order surface approximations, but it does not use the value of slope approximation in the weight update. Instead, it maintains an adaptive list of weight change values and uses these to update the weights. By removing the control of the weight updates from the magnitude of the error surface slope, better control of the weights is given to the user. By allowing each of these weight update values to grow and shrink depending on the error, resilient propagation gives fine-grain control over the best size by which to change a weight. In many runs, this algorithm may move toward a convergent state and be faster than quick propagation for many initial weights.

The training algorithm may also attempt to increase smoothness in the neural network by implementing various options such as, for example, weight decay or weight jittering. With weight decay, the training algorithm slowly decreases the magnitude of the weights relative to its current size. This is typically done in two ways: 1) by directly altering the weights, or 2) by adjusting the error function to take the size of the weights into consideration. Weight decay helps ensure that the neural network would not have to relearn the same samples that it once knew, thereby promoting generalization. The training algorithm may also implement weight jittering. In this technique, the training samples are altered by small random values so that each time the network sees a slightly different sample. This may prevent the neural network from memorizing a specific result and effectively forces the network to learn a generalized one for a small area around the actual training sample.

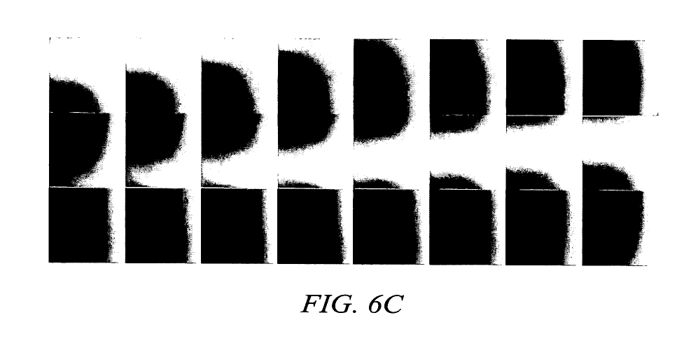

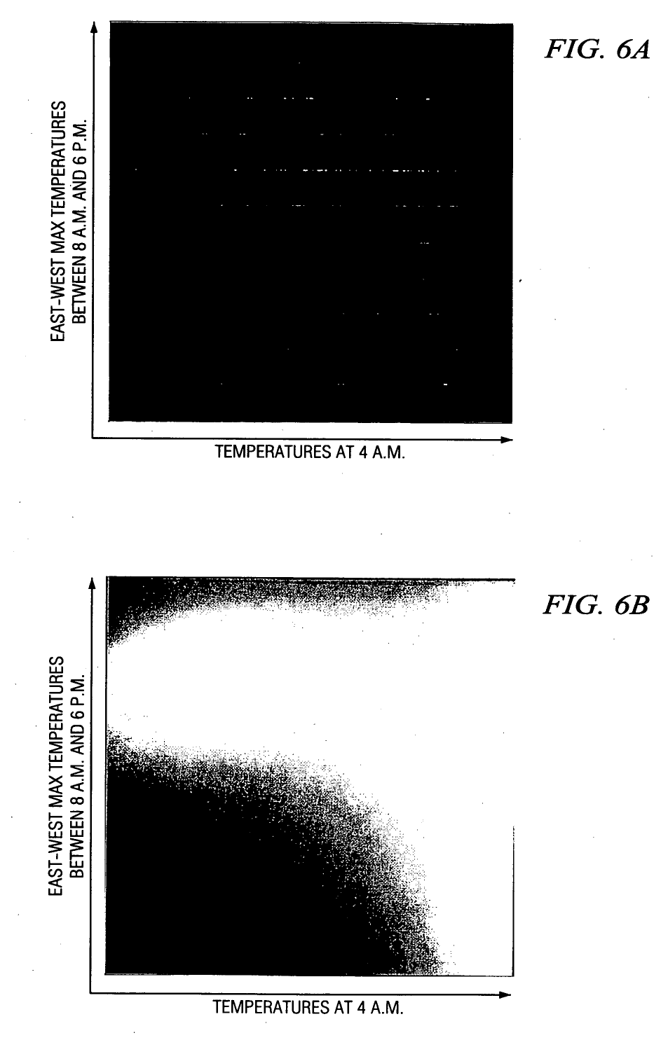

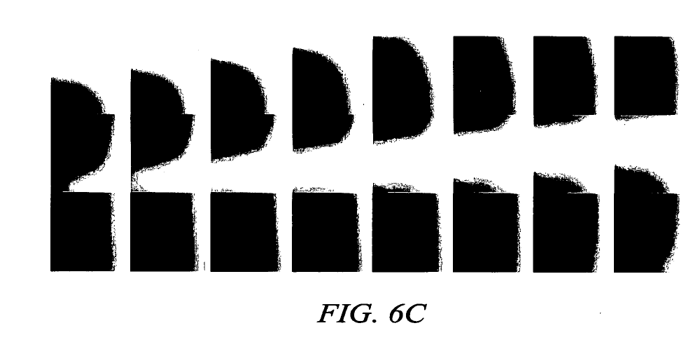

In certain embodiments, neural network 400 takes time of day, temperature at 4 am, and at what time the curve sees its maximum value as inputs, and produces normalized temperatures as outputs. For example, FIG. 6A illustrates an example training dataset for material temperatures at 4 pm. Often, the training dataset may be normalized between zero and one (0 and 1) to help neural network 400 encode data with greater possible bandwidth. For example, as illustrated in FIG. 5B, using normalized maximum temperature may allow neural network 400 to improve the discrimination of temperatures during the coolest part of the diurnal cycle (around 5 a.m.). In certain embodiments, it is not necessary for neural network 400 to learn the entire data set within some threshold. In other words, as long as the results are reasonably close, training can stop when the root mean square (RMS) error is about 3-4% of the data range because errors in this range are not likely to be noticeable by the user or a hardware sensor. Through testing, this may occur within 300 epochs, which may serve as a good stopping criterion. For example, FIG. 5C illustrates a test using a representative sample of thermal curves to help validate the completion of training. The example network may produce a near-replica (within the particular error range) of the output data representing a material thermal curve. More specifically, FIG. 5C shows that a properly trained neural network 400 may reproduce the average temperature curves when presented with mixes of input (whether mip-mapped or texture filtered material indices), even when it may not be trained with such data.

Once training is suitably complete, neural network 400 may ingest a materials and/or atmospheric file, determines some of its properties, and generate lookup table 160 comprising of, for example, 4 atmosphere states. For example, FIG. 6C illustrates twenty-four palettes of thermal curve lookups that account for certain combinations of materials including those that are averaged via texture filtering. Each palette represents encoded material temperatures for a specific time of day. The abscissa for each palette is the vertical sample at 4 a.m. shown in FIG. 13, and the ordinate is the max temperature between the times of 8 a.m. and 6 p.m. (as shown in FIG. 6B). Development environment 130 may automatically create and train neural network 400 for each atmospheric state and incorporate this into the lookup table 160. To help ensure that certain details are hidden from unauthorized users, an encryption algorithm may be employed to protect the data in table 160. One example algorithm may shift each texel by a pseudo-random amount. This makes the overall image normally appear as random noise and, therefore, may make table 160 difficult to extract meaningful information from.

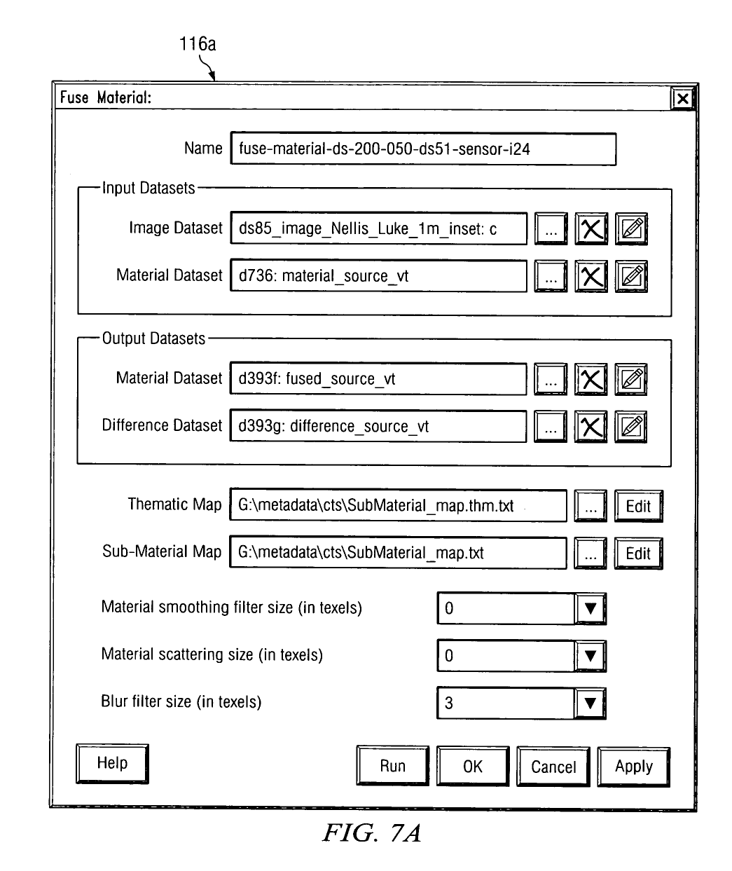

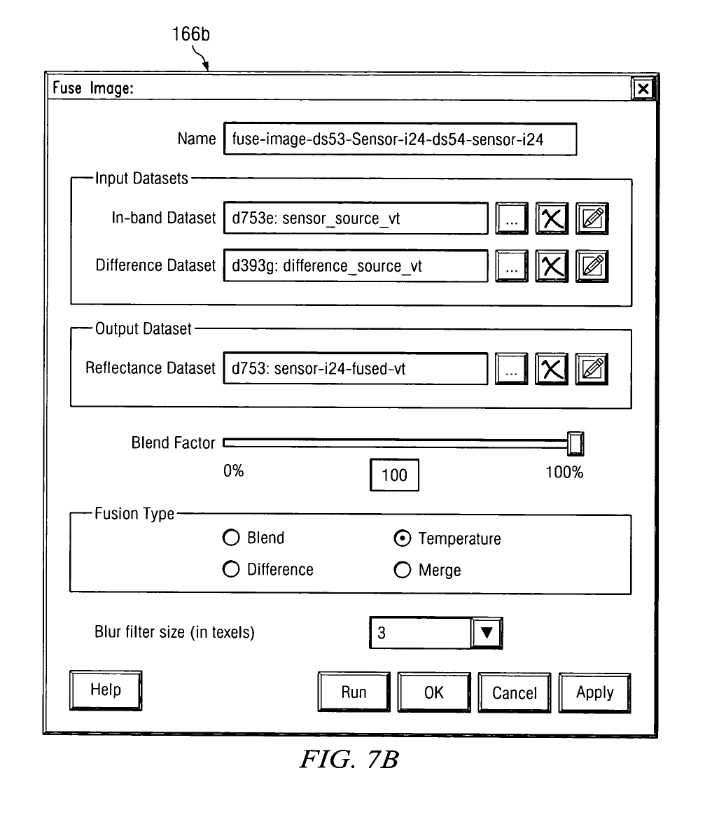

FIG. 7A-B illustrate example user interfaces for certain portions of material classification. FIG. 7A illustrates example interface 116a, which allows the user to select an out-the-window virtual texture dataset and chopped material classification data and creates two datasets—one is a further refined material classification dataset and the other is a difference texture dataset. Both output datasets are typically virtual texture datasets. The amount of refinement to the material classification data depends on the options selected in the tool. The purpose of this tool is to take raw material classification data, which has been chopped into levels of a virtual texture, and create enhanced material classification data as directed by various user-selectable options such as, for example, material smoothing, material scattering, and creation of sub-materials. Material smoothing filter size may be used to reduce the differences is texel size if there is a large difference in ground sample distance between the OTW imagery and the material classification data Material scattering size can lessen the hard edges between materials. Typically, material classified data has only a handful of materials, possibly resulting in hard edges, which are visually distracting. Material scattering attempts to identify the areas between materials where there are hard edges and, if located, mixes up the materials that make up those edges. This typically has the effect of softening (or adding noise) the edges. Blur filter size is the amount of blur that gets applied to the OTW imagery. This may enhance the output tile by blurring the texels. Of course, these options are for example purposes only and none, some, or all of these options may be used without departing from the scope the disclosure. For example, if the user already has high resolution material data, then these options may be deselected in order to pass the data through and not affect the source in any way. A possible secondary function of this process is the creation of a “difference” texture. This difference texture is derived from the average brightness of each material in the material data and the brightness derived from the out-the-window imagery. This difference captures the subtle variations from the OTW imagery which can then be applied to the relatively course grain in-band sensor texture. This difference texture may be subsequently used to enhance the in-band (or sensorized) virtual texture such as described below.

FIG. 7B illustrates example interface 116b, which allows the user to manually select a first sensorized or any other suitable texture and direct development environment 130 to fuse it with a second texture, resulting in a sensorized texture that has more high frequency detail than before. There are several fuse options, depending on the type of data the user selects. For example, illustrated GUI 116 includes four types of fusion i) blend, ii) difference, iii) temperature, and iv) merge, as well two other options: blend factor and blur filter size. In this example, blend is a straight blend of the in-band dataset with the difference dataset. For example, 50% of each input texel may be used to create the output texel. Difference is the default and includes the situation where the in-band dataset is a sensorized texture and the difference dataset is a difference texture as described above. The resulting texture often looks the same as the input, but it has the high frequency detail from the difference dataset added to it. Temperature fusion affects certain channels of thermal textures, adding high frequency detail as needed. The merge fusion directs development environment 130 to merge two datasets by applying a non-null texel in the difference dataset to the in-band dataset and ignoring null texels. The blend factor option determines how much of the difference dataset is applied, typically from 1-100%. The blur filter size option determines how much the difference dataset is blurred before being applied to the in-band dataset. As with the earlier interface 116a, these options are for example purposes only and none, some, or all of these options may be used without departing from the scope the disclosure.

Although this disclosure has been described in terms of certain embodiments and generally associated methods, alterations, and permutations of these embodiments and methods will be apparent to those skilled in the art. For example, a system may implement some or all of the material classification techniques described herein, but may determine the thermal component of the radiometric equation using a large database (opposed to a lookup table) comprising indices. Alternatively, a system may use a similar neural network to encode thermal properties in a lookup table, but may instead import high resolution or detailed material classifications. Accordingly, the above description of example embodiments does not define or constrain this disclosure. Other changes, substitutions, and alterations are also possible without departing from the spirit and scope of this disclosure.

What is claimed is:

1. A shader for dynamically providing diurnal variation in radiance-based imagery, the shader operable to:
load a virtual texture comprising a plurality of texels, each texel storing a plurality of analogical parameters;
load a thermal lookup table indexed by the plurality of analogical parameters; and
dynamically generate an at-aperture radiance image for one of a plurality of times of day based on the loaded virtual texel and the thermal lookup table.

2. The shader of claim 1, the plurality of analogical parameters comprising:
a first property of the temperature curve;
a second property of the temperature curve;
in-band reflectance; and
maximum temperature.

3. The shader of claim 1, the virtual texture comprising a sensor in-band, twenty-four hour texture.

4. The shader of claim 1, wherein the shader operable to generate an at-aperture radiance image comprises the shader operable to evaluate a radiometric equation for a plurality of image pixels of each frame in the image.

5. The shader of claim 4, the radiometric equation comprising diffuse solar/lunar reflection, specular reflection, ambient reflection, thermal emission, and path emission and scattering.

6. The shader of claim 1, further operable to texture filter a first of the analogical parameters.

7. The shader of claim 6, further operable to compress a first of the analogical parameters.

8. The shader of claim 6, further operable to texture filter the second of the analogical parameters.

9. A method for providing diurnal variation in radiance-based imagery comprising:
loading a virtual texture comprising a plurality of analogical parameters;
loading a thermal lookup table indexed by the plurality of analogical parameters; and
dynamically generating an at-aperture radiance image for one of a plurality of times of day based on the loaded virtual texel and the thermal lookup table.

10. The method of claim 9, the plurality of analogical parameters comprising:
a first property of the temperature curve;
a second property of the temperature curve;
in-band reflectance; and
maximum temperature.

11. The method of claim 9, the virtual texture comprising a sensor in-band, twenty-four hour texture.

12. The method of claim 9, wherein generating the at-aperture radiance image comprises evaluating a radiometric equation for a plurality of image pixels of each frame in the image.

13. The method of claim 12, the radiometric equation comprising diffuse solar/lunar reflection, specular reflection, ambient reflection, thermal emission, and path emission and scattering.

14. The method of claim 9, further comprising texture filtering a first of the analogical parameters.

15. The method of claim 14, further comprising compressing a first of the analogical parameters.

16. The method of claim 14, further comprising texture filtering a second of the analogical parameters.

17. A system for providing diurnal variation in radiance-based imagery comprising:
memory storing a plurality of virtual textures comprising a plurality of analogical parameters and one thermal lookup table indexed by the plurality of analogical parameters; and
a graphical processing unit (GPU) operable to:
load one of the stored virtual textures;
load one of the stored thermal lookup tables; and
dynamically generate an at-aperture radiance image for one of a plurality of times of day based on the loaded virtual texel and the thermal lookup table.

18. The system of claim 17, the plurality of analogical parameters comprising:
a first property of the temperature curve;
a second property of the temperature curve;
in-band reflectance; and
maximum temperature.

19. The system of claim 17, the virtual texture comprising a sensor in-band, twenty-four hour texture.

20. The system of claim 17, wherein the GPU operable to generate an at-aperture radiance image comprises the GPU operable to evaluate a radiometric equation for a plurality of image pixels of each frame in the image.

21. The system of claim 20, the radiometric equation comprising diffuse solar/lunar reflection, specular reflection, ambient reflection, thermal emission, and path emission and scattering.

22. The system of claim 17, the GPU further operable to texture filter a first of the analogical parameters.

23. The system of claim 22, the GPU further operable to compress a first of the analogical parameters

24. The system of claim 23, the GPU further operable to texture filter a second of the analogical parameters.
